(19) United States
(12) Patent Application Publication
(10) Pub. No.: US 2017/0002167 A1
(43) Pub. Date: Jan. 5, 2017

(54) FOAMABLE PARTICLE AND METHOD OF USE

(71) Applicant: SEKISUI VOLTEK, LLC, Lawrence, MA (US)

(72) Inventor: Keigo Shimura, North Andover, MA (US)

(21) Appl. No.: 15/197,777

(22) Filed: Jun. 30, 2016

Related U.S. Application Data
(60) Provisional application No. 62/187,128, filed on Jun. 30, 2015.

(51) Int. Cl. C08J 9/16; B32B 27/32; B32B 5/20; C08J 9/228

(52) U.S. Cl. CPC C08J 9/16; C08J 9/228; B32B 27/32; B32B 5/20; C08J 2323/06; C08J 2201/026; B32B 2323/10; B32B 2323/04

(57) ABSTRACT

A physically crosslinked foamable particle comprises a polyolefin resin and a chemical foaming agent, the foamable particle having a volume of at least about 0.002 mm³.

This application claims benefit of U.S. Provisional Application No. 62/187,128, tiled Jun. 30, 2015.

### BACKGROUND

The present disclosure relates in general to methods and compositions for producing molded thermoplastic polyolefin and elastomer foams, and more particularly, to foamable particles that may be used, for example, to produce in-situ crosslinked foam cores that can conform to a variety of mold shapes for automotive interior products, marine products, or other molded foam components.

The automotive instrument panel (IP) market is divided into three main categories: 1) Hard IP, 2) Polyolefin (PO) vacuum formed soft IP, and 3) Polyurethane (PU) foam in-place soft IP. Hard IP involves injection molding a solid plastic resin into a mold.

PO vacuum formed soft IP is made by first laminating a sheet of foam with a sheet of thermoplastic olefin (TPO) or polyvinyl chloride (PVC) foil. The combined laminate is heated to −170° C., and then placed into a mold with a vacuum to pull the malleable laminate into the mold and make it take the shape of the mold. The substrate may or may not be in the mold at the time of vacuum molding. PO vacuum formed soft IP has benefits such as having low density (e.g., around 4 pcf) and low toxicity, and being lightweight and recyclable.

A shortfall for PO vacuum formed IP is in limitation to design. Since the foil plus foam bilaminate is heated and vacuum formed to the shape of the mold, the bilaminate stretched to shape. As a result, wherever there is a deep cavity, the material has to stretch more, causing thinning out of the material, or even a tear in extreme cases. As such, PO vacuum formed soft IP design usually does not exceed a height/diameter (H/D) ratio of 0.5 to avoid extreme stretching.

PU foam in-place soft IP is done by placing a preformed TPO or PVC foil on the bottom half of a clam mold, and a substrate under the top clam mold. The molds are closed shut, and then the liquid PU foam precursor is injected into the cavity created by the gap between the top and the bottom molds. The precursor foams inside the cavity and takes the shape of the part, adhering to the foil and the substrate.

A benefit of PU foam in-place soft IP is the freedom of design. Because the foam precursor is injected into the cavity created by the skin and the substrate, it evenly fills the cavity, providing even haptics and maintaining precise gauge control throughout the part without any concern of tearing due to extreme part design.

However, the disadvantages of PU foam in-place soft IP include but are not limited to its high density (e.g., around 10 pcf, its heavy weight, inability to be recycled, as well various health and environmental hazards. PU's main ingredient is isocyanate, and being exposed to it can cause irritation of the skin and mucous membranes, chest tightness, asthma and other lung problems, as well as irritation of the eyes, nose, throat, and skin. Volatile organic compounds (VOCs) released from the foamed part can cause the same adverse effect on humans especially when the chemicals are not mixed well or remain partially unreacted.

Foamable particles containing a chemical crosslinking agent are described in Patent Pub. No. 20070249743A1, disclosing a melt-blended composition that can be extruded and cut into pellets or otherwise formed into particles which can be poured or placed into a cavity and expanded. However, chemical crosslinking produces undesirable odors in the foamed product, and does not provide for stable reproducibility of product densities, because the crosslinking level depends on many variables including temperature, time and rate of heating, and in turn, the crosslinking level affects the expandability of the foam. Too high of a crosslinking degree, for example, will result in a rigid foam and inhibit expansion, resulting in higher density than desired.

### SUMMARY

The present disclosure relates to a composition of physically crosslinked foamable particles and a method for producing physically crosslinked foam using the foamable particles.

In one aspect, a physically crosslinked foamable particle comprises a polyolefin resin and a foaming agent, and has a particle volume of at least about 0.002 mm³.

In another aspect, the physically crosslinked foamable particles are dispersed into a mold, and are heated at a temperature above an activation temperature of the foaming agent to produce a physically crosslinked foam conforming to the shape of the mold.

### BRIEF DESCRIPTION OF THE DRAWINGS

FIG. 1A is a simplified cross-section of a mold showing in-situ foaming of a sheet foam precursor for an irregularly shaped mold cavity, including potential substrate a d foil lamination.

FIG. 1B is a simplified cross-section of a mold showing in-situ foaming of foamable particles for an irregularly shaped mold cavity, including potential substrate and foil lamination.

FIG. 2 is a line graph showing resulting foam densities from various physically crosslinked foamable particle volumes for a sample formulation.

FIG. 3 is a line graph showing resulting foam densities from various physically crosslinked foamable particle volumes for additional sample formulations.

FIG. 4 is a line graph showing resulting foam densities from various physically crosslinked foamable particle volumes for additional sample formulations achieving even lower foam densities.

FIG. 5 is a line graph showing foam densities resulting from physically crosslinked foamable particles having various gel contents.

FIG. 6 is a line graph showing foam densities resulting from physically crosslinked foamable particles having varying foaming agent loading.

FIG. 7 is a bar graph showing foam surface qualities resulting from the foaming of various physically crosslinked foamable particle volumes as measured by an ink-transfer light transmittance test.

FIG. 8 is a line graph showing a relationship between foam density and Shore00 hardness values for foam produced from physically crosslinked foamable particles vs. traditional sheet foam.

FIG. 9 is a bar graph showing a comparison of thermal stabilities of foams made from physically crosslinked foamable particles versus particles containing a chemical crosslinker.

### DETAILED DESCRIPTION

Disclosed herein is a composition and method for producing physically crosslinked in-situ foam cores using physically crosslinked foamable particles, and that allows for the flexible creation of molded foam having a desired range of densities, hardness, surface characteristics, and gel content suitable for a wide range of applications. For example, due to the inventive compositions and methods, a lightweight, low toxicity, odorless, molded foam part having a complex design may be achieved, such as for automotive instrument panels or other end use applications, including foams having desired surface characteristics, laminations, and softness.

Chemical crosslinking of in-situ foam cores allows the solid foamable particles to melt and fuse uniformly with each other. For physically crosslinked foamable particles, however, the shape of the polymer is locked in place, thus the solid particles do not normally melt and fuse uniformly. Instead, the particles retain their shape while expanding, potentially leaving an unfilled gap between the expanded particles. The smaller the particle size, the smaller the size of the gap becomes in comparison to the size of each foamed particle, and thus it was assumed smaller particles would more efficiently fill a cavity when foamed in-situ as long as the foam precursors were all present in the foamable particles. However, it was found that when the foamable particle size is too small, despite the presence of the precursors in the particles, the foaming efficiency dropped to the point where the same amount of precursor by weight would not fill a cavity of the same size. In others words, the foaming efficiency was found to decrease.

In one embodiment, physically crosslinked foamable particles having a particle volume of at least about 0.002 mm³ are provided. It was discovered that for physically crosslinked foamable particles having a particle volume of at least about 0.002 mm³, the particles can achieve the same foaming efficiency as chemically crosslinked foamable particles. When exceeding a particle volume of about 1.10 mm³, the effect on resulting foam density levels off, and after a certain point there is a practical limit on particle volume because it becomes harder to evenly transfer heat throughout each particle of foamable material inside of a mold, thus taking longer to produce a foam, as well as creating larger gaps between the particles and having a negative effect on particle fusion.

In another embodiment, the foamable particles are in a physically crosslinked state prior to foaming. Once the crosslinkage is established, it will not change regardless of the subsequent heating and foaming process. Accordingly, the crosslinking degree can be tightly controlled, and result in better reproducibility of product density in the resulting foam when compared with foamable particles or compositions containing a chemical crosslinker for in-situ crosslinking. This is particularly important for foams having low densities where tighter control is needed, such as about 2.5 pcf to about 6 pcf, for example.

In another embodiment, the foamable particles are physically crosslinked to a degree of about 15% to about 85%, preferably to a degree of about 25% to about 60%, and more preferably about 30% to about 40%, with optimal efficiency achieved at a degree of about 35%. Degree of crosslinking, can also be referred to as the “gel content” of the foam. In chemical crosslinking methods, foaming efficiency increases as gel content increases, whereas it was discovered that with physical crosslinking of the foamable particles, foaming efficiency decreases as the gel content increases. Additionally, it was found that the physically crosslinked structure of the foamable particle provides a thermal stability in the resulting foamed product comparable to a chemically crosslinked foam. A suitable physical crosslinking method includes irradiation with an electron beam, for example.

In another embodiment, the particle volume, gel content, and composition of the physically crosslinked foamable particles are modified within optimal, pre-determined ranges to enable the accurate and flexible control of resulting foam densities suitable for each particular end-use application. For example, it was discovered that the larger the foamable particle volume the lower the density of foam that will result. As described above, suitable foamable particle volumes are at least about 0.002 mm³ to ensure sufficient foaming efficiency, and may exceed about 1.10 mm³ though the effect on foam density starts to level off at this particle volume.

Furthermore, the lower the gel content of the foamable particle, the lower the density of the resulting foam, but this criteria may be balanced against the need for sufficient foaming efficiency, which is strongest at about 30% to about 40%, more preferably at about 35%.

Additionally, in balance with the foamable particle volume and gel content, the amount of foaming agent used can be increased to lower the density of the resulting foam. For the foamable particles of the present invention, a suitable amount of foaming agent is about 1 to about 60 phr, preferably from about 1 to about 35 phr. and more preferably from about 5 to about 30 phr. Suitable foaming agents may include but are not limited to azodicarbonamide (ADCA), sodium bicarbonate and calcium carbonate.

Accordingly, by choosing an appropriate value for each variable of particle volume, gel content, and amount of foaming agent within the defined, optimal ranges, foam densities in the range of about 1.2 pcf to about 40 pcf may be achieved, including tight control over densities of about 2.5 pcf to about 23 pcf. Additional increases in foam density may also be achieved by over-packing the mold and constricting the foaming process inside the mold. Furthermore, the amount of foaming agent needed to produce a desired foam density can he minimized by choosing an appropriate physically crosslinked foamable particle volume and gel content to make up for the decrease in foaming efficiency. This may be desirable in cases where the foaming agent is ADCA, and the amount of ADCA residue in the resulting foam product is regulated for environmental or other reasons, for example.

In another embodiment, the particle volume of the physically crosslinked foamable particles may be selected to produce a desired surface characteristic of the resulting foam, with smaller particle volumes resulting in a smoother surface characteristic and larger particle volumes leading to a rougher surface characteristic, Control over surface characteristics of the foam is desirable for certain applications, for example, foam used for automotive instrument panels normally requires a smoother surface such that a IPO laminate does not reflect irregularities of the foam surface as it conforms to that surface over time.

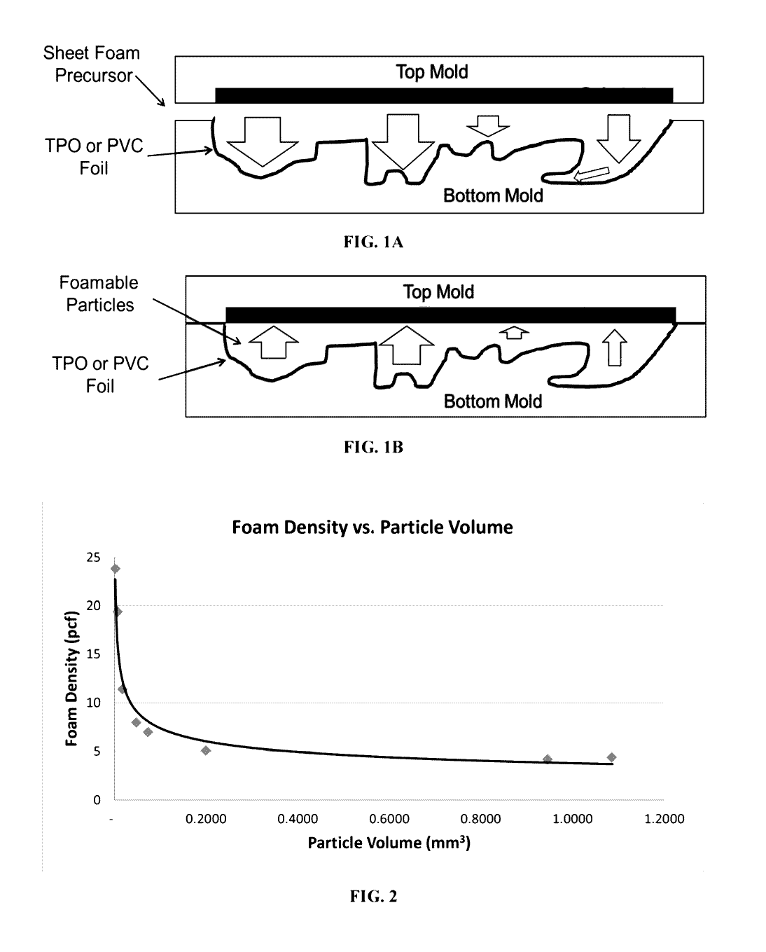

In another embodiment, physically crosslinked foamable particles are foamed in-situ in a mold cavity to yield a foam conforming to the shape of the mold. Unlike PU in-situ foaming methods where a liquid foam precursor is injected into the mold cavity and foamed, the method of the present invention involves dispersing foamable particles into the mold cavity (either before or after the molds are closed). The foamable particles inside the mold are heated to above the activation temperature of the chemical foaming agent and the temperature at which the resin softens. The particles then foam, filling the cavity to take the shape of the complex molded part. With reference to FIG. 1A, it may be appreciated that putting a foamable sheet inside a mold will not evenly fill the various gaps having different sizes and geometries, especially irregularly shaped areas with an undercut. The resulting foam core will have unfilled spaces. and where it does get filled, the haptics of the foam will be uneven. However, with reference to FIG. 1B, it may be appreciated that filling the cavity with an appropriate amount of physically crosslinked foamable particles will result in the irregularly Shaped mold cavity being evenly filled when foamed in-situ, yielding a foam core with even haptics.

Polyolefin resins suitable for use in the physically crosslinked foamable particles include but are not limited to low density polyethylene (LDPE), linear low density polyethylene (LLDPE); ethylene vinyl acetate (EVA); polypropylene (PP); ethylene propylene diene monomer (EPDM), thermoplastic olefin (TPO), thermoplastic elastomer (TPE), and rubber. Individual resins may be selected for the foamable composition of the particles, as well as blends of two or more resins.

In another embodiment, the physically crosslinked foamable particles can be foamed in-situ inside a mold and thermally bonded to a foil on one side of the resulting foam, and/or thermally bonded to a polypropylene (PP) or polyethylene (PE) substrate on the other side of the foam, allowing for one-step in-situ lamination and substrate bonding without the need for adhesives. With reference to FIG. 1B, for example, if a TPO foil is added to the mold underneath the physically crosslinked foamable particles, and the substrate is provided above the foamable particles and is also a polyolefin, the foam will directly and thermally bond to the foil rather than simply adhering, providing more structural integrity to the molded foam part.

In another embodiment, the physically crosslinked foamable particles can be used to achieve a softer loam than traditional sheet loam at the same density. Typically softer foams are achieved by using resins which often contain high VOC content. Accordingly, by utilizing the physically crosslinked foamable particles, the production of soft foams may be achieved with greater flexibility in selecting resins having lower VOC content, such as for automotive interior trim applications where VOC emissions are regulated.

### Experimental Method

The foam formulation for each tested sample was blended and extruded through a. single or twin screw extruder and a sheet die at a temperature higher than the melt temperature of the polymers and lower than an activation temperature of the foaming agent to produce a foamable sheet.

The extruded sheet was physically irradiated with an electron beam to the desired crosslinking level. The crosslinking level of the polyolefin foam was determined by preparing a 12 mm wide sample with 3 even slits inside, making four 3 mm wide strips, then cutting at an appropriate length such that the weight of the sample was between 0.047 g and 0.053 g. The weighed crosslinked polyolefin foam (A in grams) was then immersed in 25 mL of xylene at 120° C. for 24 hours. After 24 hours, the content was filtered through a 200-mesh wire mesh and left sitting inside a fume hood for a minimum of 12 hours. Subsequently, the sample was placed in a 100° C. vacuum oven set at 15 inHG for 4 hours along with the wire mesh to vacuum-dry the insolubles on the wire mesh. The dry weight (B in grams) of the insolubles was measured and the crosslinking level as calculated from the following equation: Crosslinking level % by weight)=100×(B/A).

The physically crosslinked sheet was then put through different milling techniques to make physically crosslinked particles, including those having generally spherical versus cuboidal or annular geometries. Although an extruded sheet was used, foamable compounded solids are also suitable for producing the physically crosslinked foamable particles. Furthermore, any suitable method for making the particles may be utilized, including but not limited to milling, shredding, grinding, chipping, dicing, cryogenic milling, cutting, punching, pelletization and micropelletization. Furthermore, the particles may also be directly crosslinked rather than being made from an extruded foamable sheet or foamable compounded solid that was previously crosslinked.

Foamable particles were separated with the use of various sized molecular sieves according to ASTM D6913 to produce desired particle volumes, particularly sieves NO12 (1700 μm), NO20 (850 μm), NO30 (600 μm), NO50 (300 μm), NO80 (180 μm), and NO100 (150 μm). Particle volumes were derived from the calculated average particle size (measured diameter) and geometry of the particle, e.g., spherical versus cuboidal or angular. For each sample analyzed, between about 0.7 grams to about 6.2 grams of the foamable particles from the sample were evenly packed in a 2×2×0.25 inch perimeter mold and foamed in-situ at a temperature higher than the activation temperature of the foaming agent until the particles were fully foamed. After the foaming was completed, the mold was quenched in a bucket of water for 1 minute.

After cooling, the density of the resulting teams was measured. Density was measured by weighing the resulting foam and dividing it by the volume of the mold cavity, which was 1 in³ or 0.0005787 ft³.

### EXAMPLE 1

### Particle Volume vs. Foam Density

According to the Experimental Method described above, foamable particles were prepared from the three sample foam formulations shown in Table 1 below, including low density polyolefin (LDPE) as the resin. Zinc stearate was used as a kicker, functioning to reduce the decomposition temperature of the foaming agent, as well used as a lubricant. Zinc oxide was also used as an additional kicker, while stearic acid was used as a lubricant. However, suitable kickers may also include but are not limited to urea, OBSH, aluminum stearate, barium stearate, calcium stearate, calcium oxide, titanium dioxide, and carbon black. Suitable lubricants may also include but are not limited to polyethylene wax, polyethylene glycol, and fatty acids. Suitable antioxidants include phenolic, phosphite, and sulfur based compounds.

TABLE 1

| | Sample 1 | Sample 2 | Sample 3 |
|---|---|---|---|
| | (phr) | (phr) | (phr) |
| LDPE | 100 | 100 | 100 |
| ADCA | 16 | 22 | 22 |
| Zinc Stearate | 1.2 | 1.2 | 4 |
| Antioxidant | 0.17 | 0.17 | 1.3 |
| Stearic Acid | 1 | 1 | 0.2 |
| Zinc Oxide | 0.23 | 0.23 | 1.8 |

Physically crosslinked foamable particles having generally spherical versus cuboidal or angular geometries were made from the Sample 1 formulation and crosslinked to a gel content of about 40%. An appropriate mass of foamable particles for each target density were then foamed in a mold, and the resulting densities of the foams were measured for each corresponding particle volume used as shown in Table 2 below. As can be appreciated from the average median particle size (i.e. particle diameter) versus particle volume data for spherical vs. cuboidal particle geometries, the particle volume is higher for spherical particles than for cuboidal due to the higher volume to surface ratio of a sphere.

TABLE 2
Sample 1

| Particle | Avg. Median Particle | Particle Volume | Foam Density |
|---|---|---|---|
| Geometry | Size (μm) | (mm³) | (pcf) |
| Spherical | 165 | 0.0024 | 22.9 |
| | 240 | 0.0072 | 18.6 |
| | 450 | 0.0477 | 7.7 |
| | 725 | 0.1995 | 4.9 |
| | 1275 | 1.0852 | 4.2 |
| Cuboidal | 450 | 0.0175 | 11 |
| | 725 | 0.0733 | 6.8 |
| | 1700 | 0.9455 | 4 |

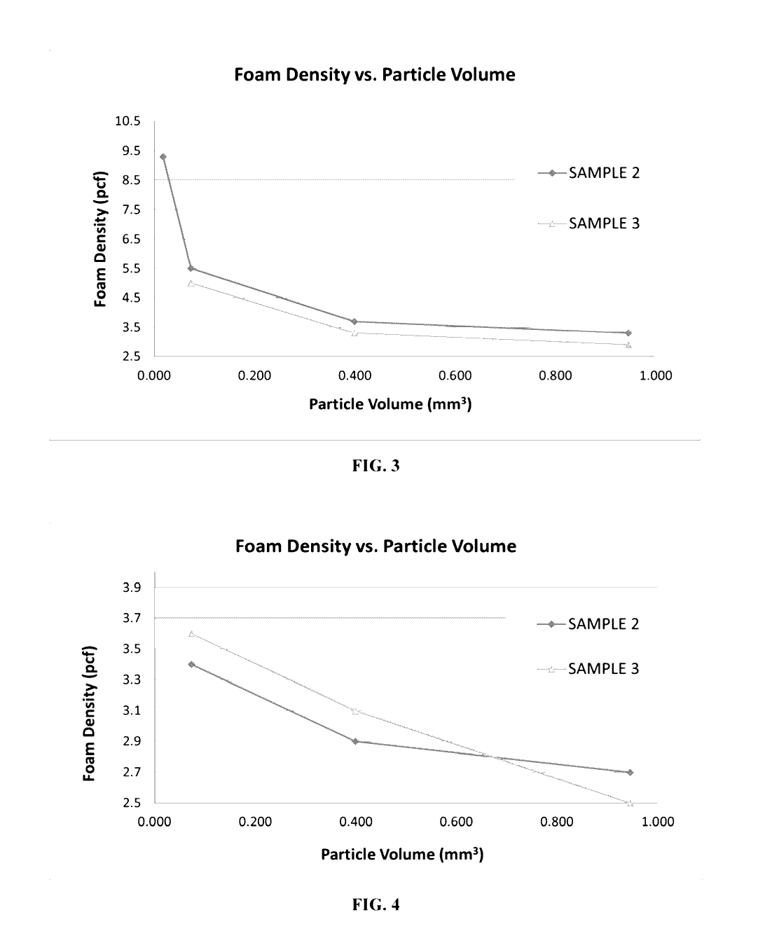

The relationship between resulting foam density and foamable particle volume is depicted in the line graph of FIG. 2 representing the data of Table 2, showing that at smaller particle volumes, the resulting foam density is high (i.e. lower foaming efficiency), whereas as the particle volume increases, foam density decreases (i.e. higher foaming efficiency). The effect of particle volume on resulting foam density can be seen leveling off starting at around 1.1 mm³. Furthermore, it was discovered, that this relationship between resulting foam density and particle volume is irrespective of particle geometry, and accordingly particle volume was determined to be a better indicator of the expected foaming efficiency of foamable particles in contrast with linear measurements such as the average median particle size based on particle diameter.

Additionally, physically crosslinked foam able particles were made from the formulation of Samples 2 and 3, and having a gel content of about 40%. An appropriate mass of the foamable particles for each target density was then foamed in a mold, with the resulting densities of the foam measured for each corresponding particle volume used, as shown in Table 3.

TABLE 3

| | Sample 2 | Sample 3 |
|---|---|---|
| Particle Volume | Foam Density | Foam Density |
| (mm³) | (pcf) | (pcf) |
| 0.946 | 3.3 | 2.9 |
| 0.399 | 3.7 | 3.3 |
| 0.073 | 5.5 | 5 |
| 0.018 | 9.3 | |

As shown in the line graph of FIG. 3 representing the data of Table 3, the relationship between resulting foam density and foamable particle volume is consistent with FIG. 2, but even lower foam densities were able to be achieved with the Sample 2 and 3 formulations by the addition of more foaming agent, and for Sample 3, even greater foaming efficiency was achieved by the use of more kicker and antioxidant to speed up the foaming agent decomposition reaction and increase the resistance to degradation by heat exposure, respectively.

Additionally, physically crosslinked foamable particles were made from the formulations of Samples 2 and 3, but this time having a gel content of about 38% for Sample 2 and 34% for Sample 3. An appropriate mass of the foamable particles for each target density was then foamed in a mold, with the resulting densities of the foam measured for each corresponding particle volume used, as shown in Table 4.

TABLE 4

| | Sample 2 | Sample 3 |
|---|---|---|
| Particle Volume | Foam Density | Foam Density |
| (mm³) | (pcf) | (pcf) |
| 0.946 | 2.7 | 2.5 |
| 0.399 | 2.9 | 3.1 |
| 0.073 | 3.4 | 3.6 |

As shown in the line graph of FIG. 4 representing the data of Table 4, the relationship between resulting foam density and foamable particle volume is consistent with FIGS. 2 and 3, but even lower foam densities were achieved, in part due to the lower gel contents of Samples 2 and 3, which was discovered to have the effect of improving foaming efficiency, also described with reference to Example 2 below.

Physically crosslinked foamable particles made from additional polyolefin resin formulations shown in Table 5 below were also tested according to the Experimental Method described previously. in particular, foamable formulations were made using ethylene vinyl acetate (EVA); linear low density polyethylene (LLDPE); polypropylene (PP); ethylene propylene diene Monomer (EPDM), thermoplastic olefin (TPO). and thermoplastic elastomer (TPE).

TABLE 5

| | Sample 4 | Sample 5 | Sample 6 | Sample 7 | Sample 8 |
|---|---|---|---|---|---|
| | (phr) | (phr) | (phr) | (phr) | (phr) |
| EVA | 100 | | | | |
| LLDPE | | 100 | 20 | | 20 |
| PP | | | 80 | 40 | 35 |
| EPDM | | | | 20 | |
| TPO | | | | 40 | |
| TPE | | | | | 45 |
| ADCA | 8.5 | 18 | 12.4 | 11.3 | 6.9 |
| Antioxidant | | 1 | 2 | 1.3 | 2 |
| Stearic Acid | 0.8 | | | | |
| Zinc Oxide | 0.12 | | | | |
| Crosslink | | | 3 | 3 | 3.5 |
| Promoter | | | | | |

Sample 4 was physically crosslinked to have a gel content of about 35%, Sample 5 about 25%. Sample 6 about 45%, Sample. 7 about 60%, and Sample. 8 about 50%. The foamable particles obtained from each of Samples 4-8 were foamed in a mold using an appropriate mass of the particles to achieve each target density, and the resulting densities of each foam were measured for the selected particle volume of 0.946 mm³, as shown in Table 6 below.

TABLE 6

| | Sample 4 | Sample 5 | Sample 6 | Sample 7 | Sample 8 |
|---|---|---|---|---|---|
| Particle | Foam | Foam | Foam | Foam | Foam |
| Volume | density | density | density | density | density |
| (mm³) | (pcf) | (pcf) | (pcf) | (pcf) | (pcf) |
| 0.946 | 12.0 | 5.8 | 4.5 | 12.9 | 12.0 |

As can be appreciated from Table 6, each resin successfully formed a foam having a predictable density based on the physically crosslinked foamable particle volume, with any slight differences attributed to the different melt index values and gel content for each formulation.

### EXAMPLE 2

### Gel Content vs. Foam Density

According to the Experimental Method described previously, a foamable extruded sheet was made from each formulation of Samples 2 and 3 shown in Table l above, and was physically irradiated with an electron beam at varying doses to produce a range of gel contents shown in Table 7 below. Physically crosslinked foamable particles having a particle volume of 0.946 mm³ were then prepared from the sheets and were foamed in a mold, with the resulting densities of the foam measured for each foamable particle gel content as shown in Table 7.

TABLE 7

| Sample 2 | | Sample 3 | |
|---|---|---|---|
| Gel Content | | Gel Content | |
| (%) | Foam Density (pcf) | (%) | Foam Density (pcf) |
| 36.7 | 2.7 | 33.6 | 2.5 |
| 38.1 | 2.7 | 34.3 | 2.5 |
| 41.7 | 3.3 | 35.4 | 2.9 |
| 47.2 | 3.6 | 46.4 | 3.2 |
| 52.7 | 4.7 | 49.4 | 4.2 |

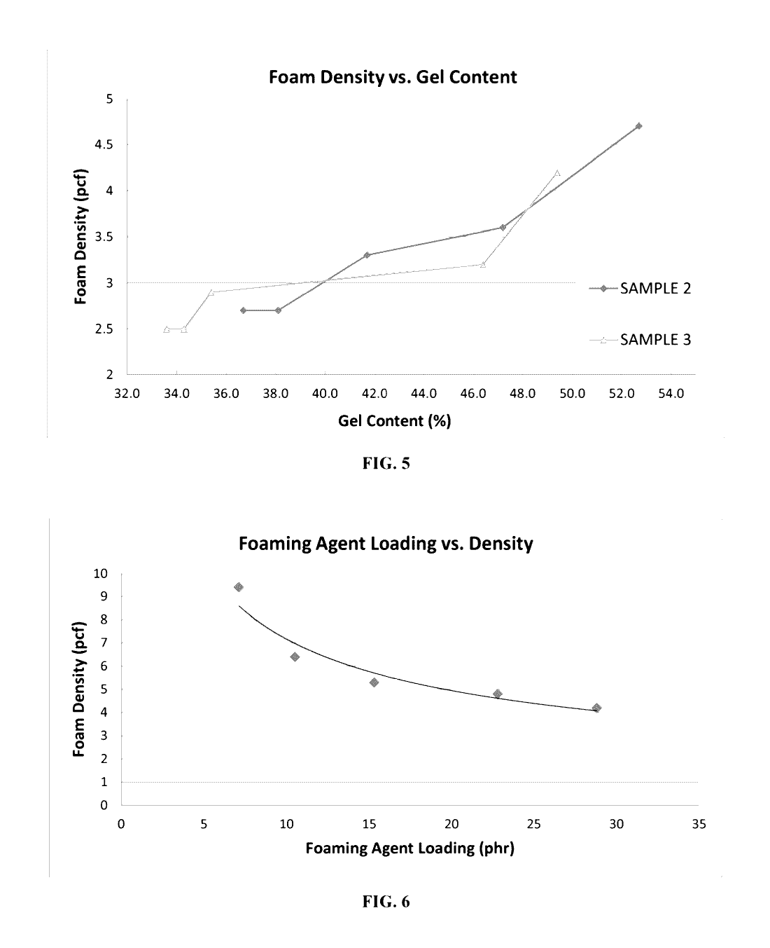

The relationship between gel content and resulting foam density for physically crosslinked foamable particles is depicted in the line graph of FIG. 5 representing the data. of Table 7. and showing that foam density increases with increasing gel content of the particles. Therefore, to achieve high foaming efficiency and low foam density, a foamable particle gel content of about 35% is suitable, and can be expected to continue to push foam density lower to as much as about 1.2 pcf, for example, before reaching a level too low to allow foaming to take place. Based on the trends ascertained from the Sample results, a foam density of 1.2 pcf may also be achieved by maximizing the loading of foaming agent in the foamable particles while using a 35% gel and a large, spherical particle geometry for maximum volume to surface ratio. As can be appreciated from the results, once the gel content goes below about 30%, the foaming efficiency worsens and density starts to rise, such as evidenced by Samples 5 and 6 described with reference to Tables 5 and 6. Sample 5, having a gel content of 25%, contained more foaming agent than Sample 6, having a gel content of 45%, yet Sample 5 resulted in a higher foam density of 5.8 pcf, while Sample 6 achieved a lower foam density of 4.5 pcf, for example. Accordingly, low gel content was found to be more detrimental to foaming efficiency than high gel content.

### EXAMPLE 3

### Foaming Agent vs. Foam Density

Physically crosslinked foamable particles were made from the formulations shown in Table 6 below, according to the Experimental Method described previously. The selected particle volume was 0.946 mm³ and the gel content was about 40%.

TABLE 8

| | Sample A | Sample B | Sample C | Sample D | Sample E |
|---|---|---|---|---|---|
| | (phr) | (phr) | (phr) | (phr) | (phr) |
| LDPE | 100 | 100 | 100 | 100 | 100 |
| ADCA | 7.1 | 10.5 | 15.3 | 22.8 | 28.8 |
| Zinc Stearate | 2 | 2 | 2 | 2 | 2 |
| Antioxidant | 0.4 | 0.4 | 0.4 | 0.4 | 0.4 |
| Stearic Acid | 0.2 | 0.2 | 0.2 | 0.2 | 0.2 |
| Zinc Oxide | 0.2 | 0.2 | 0.2 | 0.2 | 0.2 |

The physically crosslinked foamable particles from each Sample A through F having the differing levels of foaming agent (ADCA) were foamed inside a mold, and the densities measured as represented in Table 9.

TABLE 9

| | Sample A | Sample B | Sample C | Sample D | Sample E |
|---|---|---|---|---|---|
| Foaming | 7.1 | 10.5 | 15.3 | 22.8 | 28.8 |
| Agent (phr) | | | | | |
| Density (pcf) | 9.4 | 6.4 | 5.3 | 4.8 | 4.2 |

As shown in the line graph of FIG. 6 representing the data of Table 9, for the physically crosslinked foamable particles, at lower levels of foaming agent loading the resulting foam density is higher (and foaming efficiency is lower), and as the foaming agent loading increases, the density decreases (and foaming efficiency increases).

### EXAMPLE 4

### Foamable Particle Volume vs. Surface Degree of Smoothness

Physically crosslinked foamable particles having a gel content of about 40% and varying particle volumes were made from the formulation of Sample 2 shown in Table 1, according to the Experimental Method described previously. For each particle volume sample, foam having a density of 10 pcf was produced inside the mold to quantify smooth versus rough surface characteristics, measured by the following ink-transfer light transmittance test method.

Each 2×2×0.25 inch foam sample was taped onto the bottom of a metal block measuring 2×2×3.5 inches and weighing 4 lbs. Further, one layer of Pacon Art 1st Semi-Transparent Lightweight Smooth Tracing Paper was placed on top of a backing foam consisting of 0.8 mm thick EVA foam with a 25% compression deflection value of about 6.5 psi per the ASTM-3575 method. Each taped foam sample with weight above it was placed on a Ranger's Archival Ink Jet Black ink pad, and spun for three complete rotations to transfer ink to the foam surface and without externally transferring any compressive pressure to the sample other than the metal block which applied 1 psi of pressure. Each sample was then immediately removed from the ink pad, and within 5 seconds was gently placed on top of the tracing paper with the ink side down. After 30 seconds the metal block and sample were removed. Light transmittance through each stamped tracing paper for each sample was then measured according to the following method. An Extech 407026 Light Meter was attached to one open end of a light restriction tube having 3 inch inner diameter, and coated with Krylon Colors Paint +Primer Black Flat. On the other end of the light restriction tube, a Porta Trace 1417 light source with Sylvania F15T8/DSGN50 fluorescent light bulb was placed in contact with the tube, and with the light meter set to fluorescent mode, the full brightness was recorded to verify the output specs of the light source and calibration of the light meter (300 lumens). Then, a non-stamped piece of tracing paper was placed on top of the light source and in contact with the open end of the light restriction tube (opposite the light meter), and the brightness was recorded with the light meter as a control data point. To measure the light transmittance through each sample, tracing paper with each stamped impression was successively placed on the light source and in contact with the open end of the light restriction tube opposite the light meter at a distance of 5.5 inches, making sure the tube perimeter was not blocking any of the stamped impressions, and brightness was recorded for each. To calculate the percent light transmittance, the measured brightness of each stamped impression was divided by the control data for the non-stamped paper. The smoother the sample, the more ink was transferred to the paper, therefore impeding the transmittance of light. Accordingly, the lower the light transmittance the smoother the surface of the foam, and the higher the transmittance the rougher the surface of the foam.

The results of the test are summarized in Table 10, showing light transmittance (and therefore smooth versus rough surface characteristic) for foams produced using different physically crosslinked foamable particle volumes.

TABLE 10

| Particle Volume | Measured | % Light |
|---|---|---|
| (mm³) | Lumens | Transmittance |
| 0.946 | 110 | 48.7 |
| 0.399 | 93.3 | 41.4 |
| 0.073 | 91.3 | 40.5 |
| 0.018 | 91.0 | 40.3 |
| No Light | 0 | 0 |
| Light Only | 310.3 | |
| Light With Paper | 225.7 | |

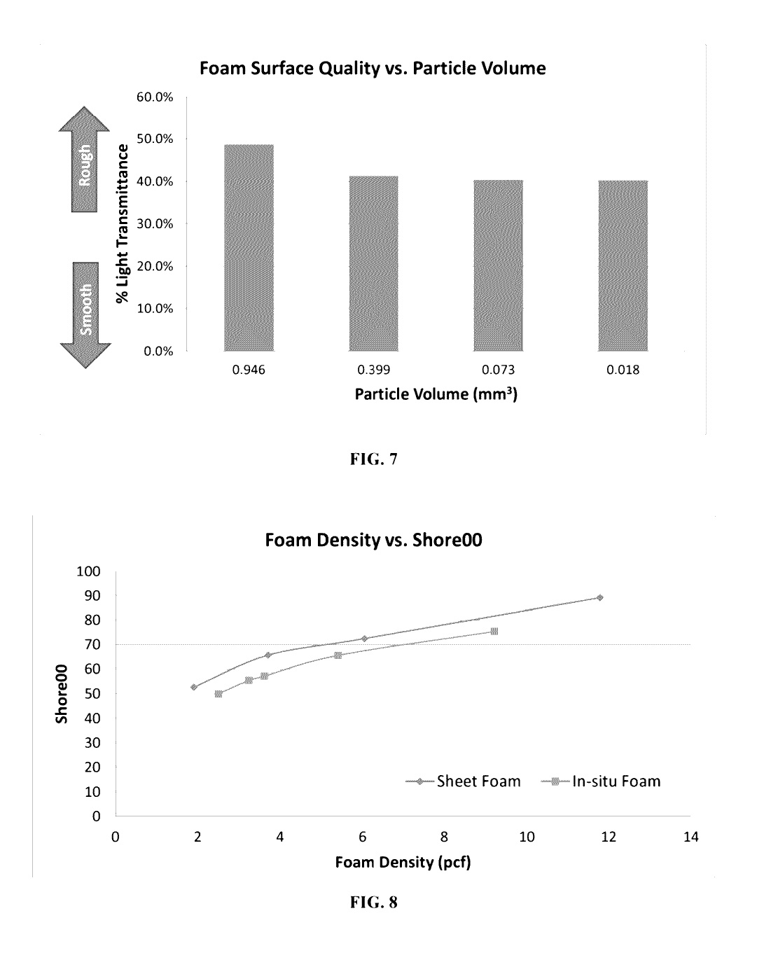

FIG. 7 is a bar graph representing the data of Table 10, showing that for the physically crosslinked foamable particles, the smaller the particle volume the smoother the surface characteristic of the resulting foam, and the larger the particle volume the rougher the surface characteristic of the resulting foam. Accordingly, optimal particle volumes may he selected to target different surface characteristics of foam produced in-situ for the varying needs of each application. Based on extrapolation of the sample results of Table 10, light transmittance values as high as 60% may be achieved using a particle volume of 1.5 mm³.

### EXAMPLE 5

### Lamination

Physically crosslinked foamable particles having a gel content of about 40% and a particle volume of about 0.073 mm³ were made from the formulation of Sample 2 shown in Table 1, according to the Experimental Method described previously. 1.1 grams of the foamable particles were added to a mold having a 3 inch×3 inch×35 mil TPO foil placed under the mold. A 4 inch×4 inch PVC mesh was placed under the TPO foil to create an emboss pattern as well as to provide an escape route for air trapped between the TPO and the bottom plate. After the foaming and cooling, the extracted sample of foam had a density of about 4.0 pcf and had an embossed TPO foil thermally bonded to it, demonstrating that a TPO lamination to the foam can be done in one step inside a mold using the physically crosslinked foamable particles.

Additionally, the same experiment above was carried out with a 1.95 inch×1.95 inch×48 mil polypropylene (PP) sheet on the other side of the mold from the TPO foil, dropped in on top of the physically crosslinked foamable particles. Again, after the foaming and cooling. the extracted sample of foam was about 4.0 pcf and with an embossed TPO foil thermally bonded onto one side and the PP substrate thermally bonded to the other side, demonstrating that a TPO lamination to the in-situ foam and the substrate bonding can be done inside a mold in one step using the physically crosslinked foamable particles. A polyethylene (PE) sheet may also be used to thermally bond as a foam substrate.

In addition, per the Experimental Method described previously, a foam formulation containing 100 parts of low density polyethylene (LIVE) was mixed with 16.1 phr of chemical foaming agent (ADCA), 0.2 parts of zinc. oxide, 2.0 parts of zinc stearate, 0.2 parts of lubricant, and 0.2 parts of anti-oxidant was used to make a foamable sheet, and was crosslinked to a level of 40%. Foamable particles having a particle volume of about 0.946 mm³ were then prepared and foamed inside of a mold, with the previously described TPO foil placed under the mold. After the foaming and cooling, the extracted sample of foam had a density of 5.1 pcf and had an embossed TPO foil thermally bonded to it.

Additionally, the same particles from above were also foamed inside a mold containing a 1.95 inch×1.95 inch×48 mil polypropylene (PP) or polyethylene (PE) sheet that was dropped into the mold from above the physically crosslinked foamable particles. After the foaming and cooling, the extracted sample of foam had a density of 5.1 pcf with an embossed TPO foil thermally bonded onto one side and a solid PP or PE substrate thermally bonded to the other side.

Although a TPO foil was used in the above examples, other suitable polyolefin based foils may be thermally bonded using the physically crosslinked foamable particles, such as TPE, for example. Alternatively for non-polyolefin based foils such as PVC and natural or synthetic leathers, an adhesive may be used to establish a bond with the foam.

### EXAMPLE 6

### Shore00 Hardness

According to the Experimental Method described previously, physically crosslinked foamable particles having a. gel content of about 40% and a particle volume of about 0.946 mm³ were made from the Sample 2 formulation shown in Table 1, to produce the four in-situ foam samples shown in Table 12 below, with the density and Shore00 value measured for each sample. For comparison, four samples of a traditional sheet foam formulation were also prepared according to the formulations shown in Table 11, and were measured for density and Shore00 values as also shown in Table 12.

TABLE 11

| | T1 | T2 | T3 | T4 |
|---|---|---|---|---|
| | (phr) | (phr) | (phr) | (phr) |
| LDPE | 100 | 100 | 100 | 100 |
| ADCA | 15.1 | 7.6 | 4.8 | 2.1 |
| Zinc Stearate | 1.2 | 1.2 | 1.2 | 1.2 |
| Antioxidant | 0.17 | 0.17 | 0.17 | |
| Stearic Acid | 0.5 | 0.5 | 0.5 | 0.5 |
| Zinc Oxide | 0.2 | 0.2 | 0.2 | 0.5 |

TABLE 12

| Sheet Foam | | | In-situ Foam | Density | |
|---|---|---|---|---|---|
| Samples | Density (pcf) | Shore00 | Samples | (pcf) | Shore00 |
| T1 | 1.9 | 52.8 | S1 | 9.2 | 75.5 |
| T2 | 3.7 | 65.9 | S2 | 5.4 | 65.8 |
| T3 | 6.1 | 72.6 | S3 | 3.6 | 57.3 |
| T4 | 11.8 | 89.3 | S4 | 3.2 | 55.5 |

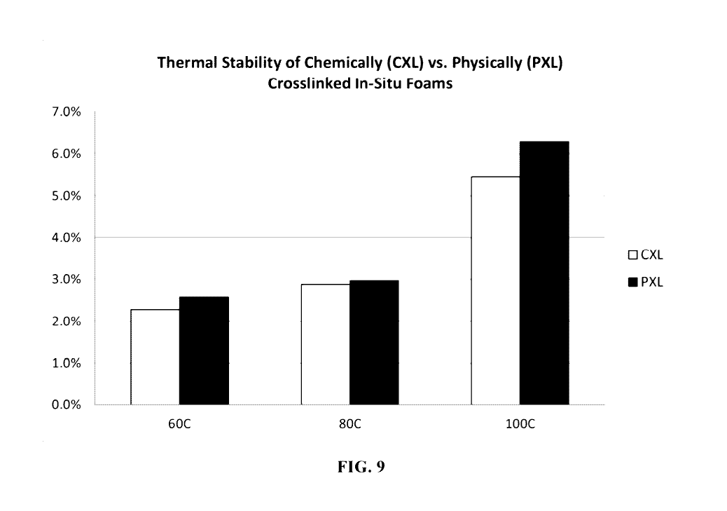

FIG. 8 is a line graph representing the data of Table 11, showing that the Shore00 curve is lower (thus softer) for foams made by the physically crosslinked foamable particles than for traditional sheet foam having the same densities. Softer foams often require the use of resins having high volatile organic compound (VOC) emissions, which can result in foams that do not meet various environmental and industry regulations, such as for the automotive interior trim market. Accordingly, by using the physically crosslinked foamable particles, a softer foam can be achieved than traditional sheet foam at the same density, thereby allowing for more flexibility in choosing resins having lower VOC emissions in foam formulations.

### EXAMPLE 7

### Thermal Stability

According to the Experimental Method described previously, physically crosslinked foamable particles having a gel content of about 40% and a particle volume of about 0.946 mm³ were made from the Sample 2 formulation shown in Table 1, and were foamed inside a mold. For comparison, a foamable particle with the same particle volume was formulated using a chemical crosslinker, the formulation comprising 100 phr of LDPE, 22.8 phr of ADCA, 1.3 phr of antioxidant, 1.8 phr of zinc oxide, 4.0 phr of zinc stearate, 0.2 phr of stearic acid, and 3 phr of peroxide, and was foamed inside a mold to produce a chemically crosslinked foam sample having about 65% gel content. Both samples were exposed to 60° C. 80° C., or 100° C. temperatures for 24 hours. The length, width, and the gauge of the samples were measured before and after the beat cycle, and the change in dimensions were compared, as shown in Table 13.

TABLE 13

| | 60° C. | 80° C. | 100° C. |
|---|---|---|---|
| Chemically | 2.3% | 2.9% | 5.4% |
| Crosslinked | | | |
| Physically | 2.6% | 3.0% | 6.3% |
| Crosslinked | | | |

As shown in bar graph of FIG. 9 representing the data of Table 13, foams produced from physically crosslinked foamable particles exhibit good thermal stability comparable to foams made from foamable particles containing a chemical crosslinker.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A physically crosslinked foamable particle comprising a polyolefin resin and a foaming agent, the foamable particle having a particle volume of at least about 0.002 mm³.

2. The physically crosslinked foamable particle of claim 1, wherein the foamable particle has a gel content of about 15% to about 85%.

3. The physically crosslinked foamable particle of claim 1, wherein the polyolefin resin comprises at least one selected from the group consisting of LDPE, LLDPE, EVA, PP, EPDM, TPO, TPE and rubber.

4. The physically crosslinked foamable particle of claim 1, further comprising about 1 phr to about 60 phr of the foaming agent.

5. The physically crosslinked foamable particle of claim 1, wherein the foaming agent comprises at least one selected from the group consisting of azodicarbonamide, sodium bicarbonate and calcium carbonate.

6. The physically crosslinked foamable particle of claim 1, wherein a foam produced from the foamable particle has a density of about 1.2 pcf to about 40 pcf.

7. The physically crosslinked foamable particle of claim 1, wherein a foam produced from the foamable particle has a surface degree of smoothness of about 40% to about 60% based on the ink-transfer light transmittance test method.

8. The physically crosslinked foamable particle of claim 1, wherein a foam produced from the foamable particle has an average Shore00 hardness that is lower than the average Shore00 hardness of a sheet foam of the same density.

9. The physically crosslinked foamable particle of claim 1, wherein a foam produced from the foamable particle has a Shore00 hardness of about 55 to about 75.

10. A foam produced using the physically crosslinked foamable particle of claim 1, wherein the foam is thermally bonded to at least one of a thermoplastic olefin toil and a thermoplastic olefin substrate.

11. The foam of claim 10, wherein the thermoplastic olefin substrate is a polypropylene or polyethylene sheet.

12. The physically crosslinked foamable particle of claim 1, wherein the particle is produced from a foamable compounded solid.

13. The physically crosslinked foamable particle of claim 12, wherein the foamable compounded solid is physically crosslinked.

14. The physically crosslinked foamable particle of claim 12, wherein the foamable compounded solid is in the form of an extruded sheet.

15. A method of making an in-situ foam using the physically crosslinked foamable particle of claim 1, comprising:
dispersing the physically crosslinked foamable particles inside of a mold;
heating the physically crosslinked foamable particles to a temperature above an activation temperature of the foaming agent; and
foaming the particles inside of the mold to produce a physically crosslinked foam conforming to the shape of the mold.
